(19) United States
(12) Patent Application Publication
(10) Pub. No.: US 2026/0073610 A1
(43) Pub. Date: Mar. 12, 2026

(54) Systems and Methods for Streaming Different Parts of a Three-Dimensional Model at Different Resolutions

(71) Applicant: Illuscio, Inc., Culver City, CA (US)

(72) Inventor: Joseph Nordling, Roeland Park, KS (US)

(73) Assignee: Illuscio, Inc., Culver City, CA (US)

(21) Appl. No.: 18/883,625

(22) Filed: Sep. 12, 2024

(51) Int. Cl. G06T 15/00

(52) U.S. Cl. CPC G06T 15/00

(57) ABSTRACT

An adaptive streaming system dynamically streams different parts of a three-dimensional (3D) model at different resolutions to maximize visual detail and quality in response to changing network performance and/or client device rendering performance. The system receives a request to view the 3D model from a particular field-of-view. The system associates different priorities to different parts of the 3D model, selects first Gaussian splats associated with nodes at a first level in a tree based on the first Gaussian splats representing the different parts of the 3D model in the particular field-of-view with a first priority, and selects second Gaussian splats associated with nodes at a second level in the tree structure based on the second Gaussians splats representing the different parts of the 3D model in the particular field-of-view with a second priority. The system streams the selected Gaussian splats in response to the request.

### BACKGROUND

A three-dimensional (3D) model or asset may represent a 3D form and may be defined as a polygonal model with meshes, a point cloud with points, or with primitives of another 3D format. The amount of data for representing the 3D form is orders of magnitude more than the amount of data used to represent the same object or scene in two dimensions or in a two-dimensional (2D) image.

Data networks have a limited transfer capacity. The bandwidth, latency, and/or other data network performance parameters may be insufficient for a real-time or low-latency transfer of a 3D model between a server and a client. The data network performance limitations are further strained when the 3D model is one of several 3D assets that are streamed as part of a 3D environment (e.g., a 3D game, a virtual reality experience, a spatial computing experience, etc.) or when the 3D model is dynamic, interactive, and/or animated and changes shape and form.

To accommodate the data network performance limitations, a 3D model may be generated at progressively lower resolutions with each lower resolution encoding of the 3D model having fewer primitives, reduced detail, and less total data. Generating a 3D model at a lower resolution includes uniformly changing the visual quality across the entirety of the 3D model. In other words, the visual quality is not preserved in one region and degraded in another region. All regions of the 3D model are degraded by the same amount.

### BRIEF DESCRIPTION OF THE DRAWINGS

FIG. 1 illustrates an example of streaming different parts of a 3D model at different resolutions in accordance with some embodiments presented herein.

FIG. 2 illustrates an example of generating Gaussian splats to represent the primitives of a 3D model at a similar level-of-detail and with less data in accordance with some embodiments presented herein.

FIG. 3 presents a process for defining a tree-based representation of a 3D model using Gaussian splats in accordance with some embodiments presented herein.

FIG. 4 illustrates an example of generating a Gaussian splat for a parent node in the tree-based representation based on the Gaussian splats that are associated with children nodes of the parent node in accordance with some embodiments presented herein.

FIG. 5 illustrates an example of optimizing the tree-based representation in accordance with some embodiments presented herein.

FIG. 6 presents a process for presenting a requested view of a 3D model with differing resolutions across the requested view in accordance with some embodiments presented herein.

FIG. 7 illustrates an example of generating different parts of a requested field-of-view at different resolutions using dynamically selected and streamed Gaussian splats in accordance with some embodiments presented herein.

FIG. 8 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Provided is an adaptive streaming system and associated methods for dynamically streaming different parts of a three-dimensional (3D) model at different resolutions to maximize visual detail and quality in response to changing network performance and/or client device rendering performance. The adaptative streaming system uses the different resolutions at the different parts of the 3D model to preserve visual quality at designated regions of high importance while reducing visual quality and encoded data for other regions of low importance so that the 3D model may be streamed over bandwidth limited networks without uniform quality loss across the entirety of the 3D model. Accordingly, the adaptive streaming system streams the same 3D model across different data networks with different performance parameters with a non-uniform degradation of the 3D model so that visual consistency is maintained in the designated regions of high importance while data reduction and/or bandwidth savings are obtained from the other regions in order to accommodate different network constraints.

In support of the dynamic streaming, the adaptive streaming system generates a tree-based representation of a 3D model to include Gaussian splats for the different resolution representations of different 3D model parts or regions. The Gaussian splats associated with the leaf nodes of the tree-based representation provide a low or minimal loss representation of the 3D model with less total data than a mesh-based or point-based definition of the 3D model. In some embodiments, the Gaussian splats associated with the leaf nodes may have a one-to-one correspondence to the meshes, points, or other primitives of the original high-resolution 3D model. The adaptive streaming system generates Gaussian splats for the parent nodes and other upper-level nodes of the tree-based representation by combining the data from the Gaussian splats at the lower levels of the tree-based representation that are directly linked to that parent node or upper-level node. Accordingly, the Gaussian splats associated with the nodes at the different levels of the tree-based representation represent different sized regions of the 3D model at different resolutions or quality levels with a parent node being at a lower resolution and lesser quality level for the regions spanned by its children nodes.

The adaptive streaming system traverses to different levels of the tree-based representation in response to receiving a request for the 3D model. The request may specify viewing of the 3D model from a particular field-of-view or render position or may request the entirety of the 3D model from an initial or default field-of-view.

The adaptive streaming system determines performance of the network or network path to the requesting client device. In some embodiments, the adaptive streaming system also determines the rendering performance of the requesting client device.

Based on the determined network and/or rendering performance, the adaptive streaming system determines an amount of data that may be streamed to the requesting client device to produce a desired user experience thereon. The adaptive streaming system selects Gaussian splats associated with nodes at different levels of tree-based representation with data for the requested field-of-view that equals or is less than the determined amount of data, that maximize visual quality and detail at important regions of the requested field-of-view, and that reduce visual quality and detail at lesser important regions of the requested field-of-view.

In some embodiments, the important regions may correspond to the regions at the center of the requested field-of-view and the lesser important regions may correspond to the regions at the periphery of the requested field-of-view. In some other embodiments, the important regions may correspond to designated regions of the 3D model that are in the requested field-of-view and that have been tagged as important. For instance, the important regions may correspond to the head of a 3D character that is anywhere in the requested field-of-view and the lesser important regions may correspond to other body parts of the 3D character anywhere in the requested field-of-view.

In any case, the adaptive streaming system traverses down from the root node of the tree-based representation to nodes at different levels in order to stream the requested field-of-view using Gaussian splats that form different parts of the requested field-of-view at different resolutions. The adaptive streaming system streams the selected Gaussian splats to the requesting client device and reevaluates which Gaussian splats at the different levels of the tree-based representation to stream to the requesting client device for subsequent requests that change the field-of-view.

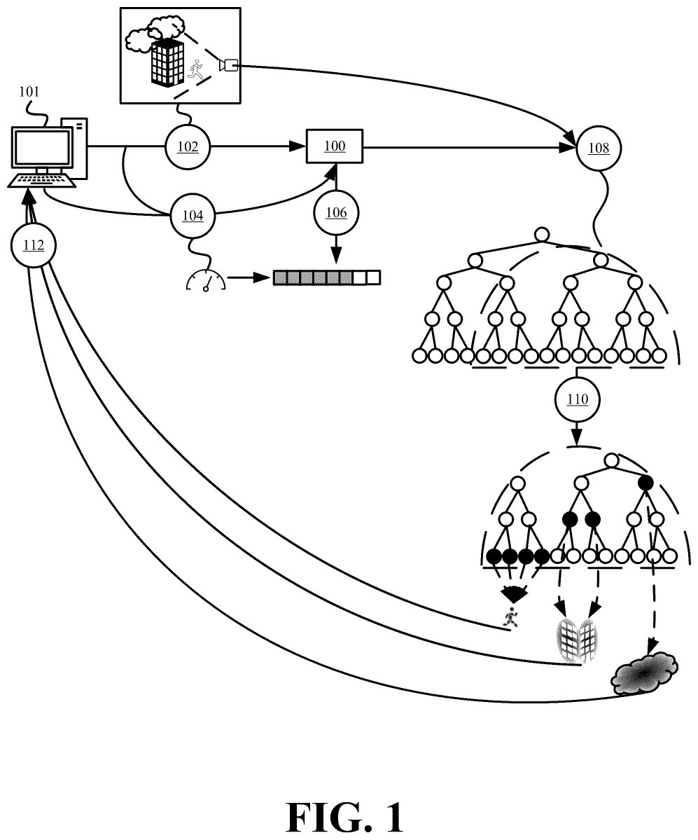

FIG. 1 illustrates an example of streaming different parts of a 3D model at different resolutions in accordance with some embodiments presented herein. Adaptive streaming system 100 receives (at 102) a request over a data network from client device 101. The request specifies a field-of-view at which to present the 3D model. The request may be a HyperText Transfer Protocol (HTTP) GET request message or another request message type of the same or another protocol. The request may specify a render or viewing position within a 3D space of the 3D model at which to render the 3D model. Accordingly, the requested field-of-view may include some parts or regions of the 3D model while other parts or regions of the 3D model are obscured or hidden.

Adaptive streaming system 100 determines (at 104) network and/or rendering performance. For instance, adaptive streaming system 100 may test the performance of the network path to client device 101 when establishing a connection or session with client device 101. Testing the network performance may including the available bandwidth and/or latency associated with the network path. Alternatively, adaptive streaming system 100 may test the network performance after receiving (at 102) the request using pings or by exchanging test packets with client device 101. Rendering performance of client device 101 may be determined (at 104) based on data included in the header of the request. For instance, the header data may identify the device model or type and adaptive streaming system 100 may determine (at 104) the rendering resources associated with the identified device model or type. Similarly, adaptive streaming system 100 may determine (at 104) whether client device 101 is a mobile device or desktop device based on the header data and may estimate the rendering performance based on the device classification.

Adaptive streaming system 100 determines (at 106) a total amount of data at which to stream the requested field-of-view based on the determined (at 104) network and/or rendering performance. In some embodiments, the total amount of data is set in order to provide a desired user experience or frame rate for an animation, game, or other dynamic experience that accounts for the constraints imposed by the determined (at 104) network and/or rendering performance. In some embodiments, the total amount of data is set in order to stream the requested field-of-view in real-time or within a particular time envelope so that client device 101 is not left waiting extended periods of time before rendering the requested field-of-view or so that the client device 101 may continuously render the requested field-of-view as part of a 3D experience without buffering, stuttering, or lag.

Adaptive streaming system 100 identifies (at 108) a branch from a tree-based representation of the 3D model that includes Gaussian splats for creating the requested field-of-view at different resolutions. Specifically, adaptive stream system 100 retrieves the tree-based representation that contains the different Gaussian splats for representing the 3D model at different resolution and traverses down the tree-based representation until the one or more nodes representing the regions of the requested field-of-view are found.

Adaptive streaming system 100 selects (at 110) different nodes at different levels along the branch so that the total amount of data for the Gaussian splats associated with the selected nodes equals or is less than the determined (at 106) total amount of data and so that the resolution or quality for designated important parts or regions within the requested field-of-view are preserved using higher resolution Gaussian splats that provide shapes, forms, and visual characteristics for smaller regions or parts of the 3D model in the requested field-of-view than lower resolution Gaussian splats that are used to provide shapes, forms, and visual characteristics for other larger regions or parts of the 3D model in the requested field-of-view that are of lesser importance. As shown, adaptive streaming system 100 selects (at 110) a first set of leaf nodes to represent important regions in the requested field-of-view with Gaussian splats of a first size and resolution, a second set of parent nodes to represent regions surrounding the important regions with Gaussian splats of a second larger size and lower resolution, and a third set of grandparent nodes to represent regions furthest from the important regions with Gaussian splats of a third size that is larger than the second size and a resolution that is less than the resolution of the Gaussian splats associated with the second set of parent nodes.

Adaptive streaming system 100 streams (at 112) the Gaussian splats associated with each of the selected (at 110) nodes to client device 101 in response to the request from client device 101. The Gaussian splats that are streamed (at 112) collectively form the requested field-of-view with different parts of the field-of-view being presented at different resolutions and levels-of-detail. The streamed (at 112) Gaussian splats present the requested field-of-view at a non-uniform resolution to account for the network and/or rendering constraints and to ensure that client device 101 receives the requested field-of-view of the 3D model with a certain quality-of-experience in which the quality or detail of the important regions of the 3D model in the requested field-of-view are preserved or are minimally degraded relative to other regions in order to accommodate the network and/or rendering constraints.

Adaptive streaming system 100 may generate the Gaussian splats based on an original or high-resolution encoding of the 3D model. The original or high-resolution encoding of the 3D model is defined with the primitives of a 3D format. In some embodiments, the primitives may include meshes of a polygonal model. Each mesh may be defined with multiple sets of coordinates in a 3D space for the different vertices of that mesh and with one or more values for the color, transparency, reflectivity, and/or other visual characteristics for rendering or visually presenting that mesh. In some embodiments, the primitives may include a distributed set of disconnected points of a point cloud. Each point may be defined with positional coordinates for a position in 3D space and with one or more values for the color, transparency, reflectivity, and/or other visual characteristics for rendering or visually presenting that point at its defined position in the 3D space.

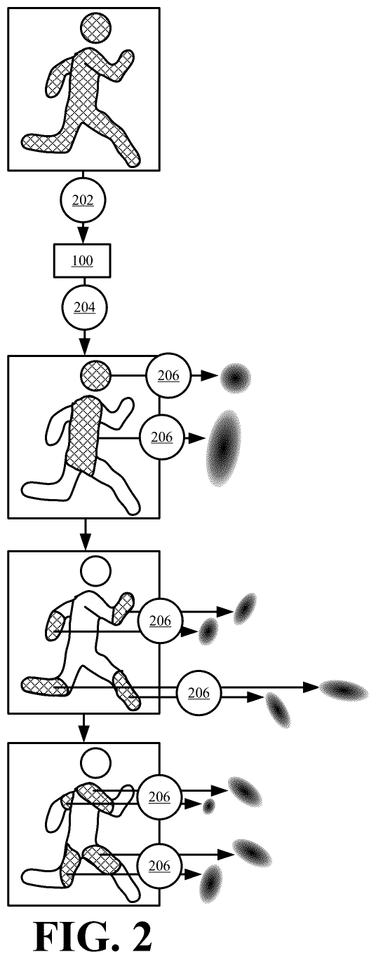

FIG. 2 illustrates an example of generating Gaussian splats to represent the primitives of a 3D model at a similar level-of-detail and with less data in accordance with some embodiments presented herein. Adaptive streaming system 100 receives (at 202) the primitives that form the 3D model. In this example, the primitives correspond to polygons of a mesh model. In some embodiments, the primitives may be disconnected points of a point cloud. Receiving (at 202) the primitives includes receiving the positional coordinates and visual characteristics associated with each primitive of the 3D model.

Adaptive streaming system 100 selects (at 204) two or more neighboring primitives and generates (at 206) a Gaussian splat to replace the two or more neighboring primitives. To minimize loss of visual quality or detail, adaptive streaming system 100 may select (at 204) two or more neighboring primitives with visual characteristics (e.g., color values, transparency values, reflectivity values, etc.) that are the same or that differ by less than a threshold amount (e.g., red, green, and blue color values that are within 10% of one another).

Generating (at 206) a Gaussian splat for the selected (at 204) two or more neighboring primitives includes defining a single splat primitive with a shape that closely matches the shape formed by the selected (at 204) two or more neighboring primitives. The single splat primitive may be defined with a positional coordinate at the center of the two or more neighboring primitives. The single splat primitive may also be defined with a radius, covariance value (e.g., a covariance matrix), or 3D scale value for specifying the shape or form of the splat primitive that is centered on the positional coordinate. The single splat primitive inherits the visual characteristics of the selected (at 204) two or more neighboring primitives. For instance, the color of the splat primitive may be an average of the colors defined for the selected (at 204) two or more neighboring primitives. In some embodiments, the splat primitive is defined with spherical harmonics. The spherical harmonics may represent the color of the splat primitive from different directions or viewing angles.

In some embodiments, adaptive streaming system 100 generates (at 206) the Gaussian splats using a Neural Radiance Field (NeRF) and/or directly from two-dimensional (2D) images of an object or scene represented by the 3D model. The NeRF uses deep machine learning techniques and/or neural networks to model the 3D shape or form of the imaged object or scene and to create the 3D form of the imaged object or scene using the splat primitives.

Adaptive streaming system 100 continues generating (at 206) the Gaussian splats for different sets of primitives until the entire 3D model can be constructed from the Gaussian splats. In some embodiments, adaptive streaming system 100 generates (at 206) the Gaussian splats so that the final rendering produced from the Gaussian splats and the original primitives of the 3D model differ by less than a threshold amount (e.g., 5%). In some such embodiments, adaptive streaming system may set the threshold amount to minimize quality and/or detail loss across all regions or parts of the 3D model. The splat primitives or Gaussian splats generated for the 3D model need not be of uniform sizes. In fact, a single Gaussian splat may be defined to represent a large region of the 3D model with uniform coloring and a uniform texture or structure, and multiple Gaussian splats may be defined to represent a smaller region of the 3D model with wildly differing colors or with differing textures or structures. Accordingly, greater data reduction with minimal quality loss may be achieved by representing 3D models that have less variance across their surfaces with Gaussian splats than for 3D models that have greater variance across their surfaces. In any case, minimizing quality loss and/or detail loss may result in more Gaussian splats being defined to represent smaller regions of the 3D model or fewer primitives of the 3D model, whereas allowing for increased quality loss and/or detail loss may result in fewer Gaussian splats being defined to represent larger regions of the 3D model or larger numbers of the primitives.

Adaptive streaming system 100 uses the generated high-resolution Gaussian splats to generate additional lower detail or lower resolution Gaussian splats for the 3D model. Adaptive streaming system 100 arranges the Gaussian splats for the different resolution representations of the 3D model about different levels of a tree structure, and uses the tree structure to dynamically select and stream a requested field-of-view from the 3D model at different resolutions. Specifically, adaptive streaming system 100 traverses to different depths or levels in the tree to present different parts of the requested field-of-view at different quality levels and/or with different loss so that data reduction for streaming the requested field-of-view over a data network is achieved with minimal quality loss to important elements of the 3D model in the requested field-of-view and greater quality loss to lesser important elements of the 3D model in the requested field-of-view.

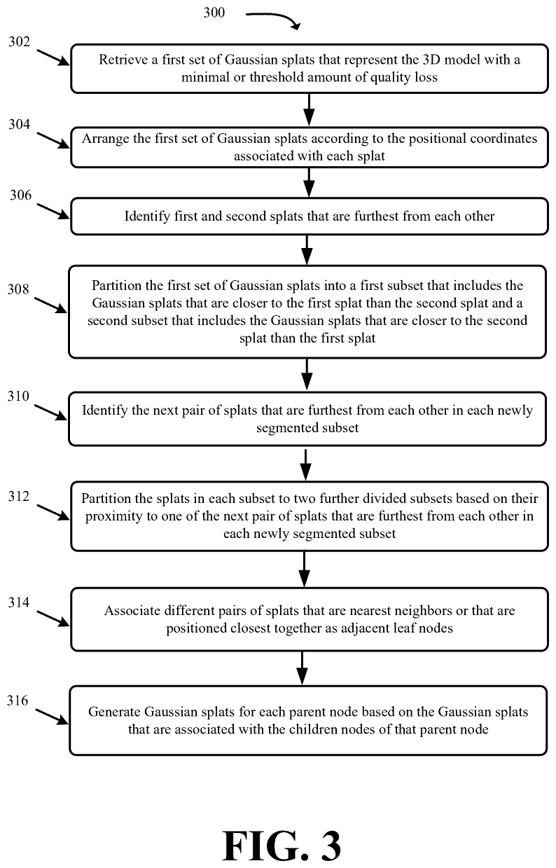

FIG. 3 presents a process 300 for defining a tree-based representation of a 3D model using Gaussian splats in accordance with some embodiments presented herein. Process 300 is implemented by adaptive streaming system 100. Adaptive streaming system 100 includes one or more servers, devices, or machines with processing, memory, storage, network, and/or other hardware resources for the efficient streaming of 3D models at different resolutions to client devices.

Process 300 includes retrieving (at 302) a first set of Gaussian splats that represent the 3D model with a minimal or threshold amount of quality loss. The first set of Gaussian splats may be generated by adaptive streaming system 100 from the original primitives forming the 3D model or by converting 2D images of an object or scene to Gaussian splats using a NeRF-based approach. Alternatively, the first set of Gaussian splats may be generated by a third-party or obtained from a data repository of 3D models.

Process 300 includes arranging (at 304) the first set of Gaussian splats according to the positional coordinates associated with each splat. In some embodiments, arranging (at 304) the first set of Gaussian splats may include plotting the splats in a 3D space based on their positional coordinates. In some embodiments, arranging (at 304) the first set of Gaussian splats may include sorting the Gaussian splats in an array or other structure according to their positional coordinates.

Adaptive streaming system 100 then begins defining the leaf nodes of the tree-based representation using an Approximate Nearest Neighbor (ANN) approach, loading the Gaussian splats into a distance-based ANN, or using another technique for efficiently associating the Gaussian splats in the tree to specific regions or parts of the 3D model. To define the leaf nodes, process 300 includes identifying (at 306) first and second splats from the first set of Gaussian splats that are furthest from each other. Process 300 includes partitioning (at 308) the first set of Gaussian splats into a first subset that includes the Gaussian splats that are closer to the first splat than the second splat and a second subset that includes the Gaussian splats that are closer to the second splat than the first splat. Process 300 includes repeatedly identifying (at 310) the next pair of splats that are furthest from each other in each newly segmented subset and further partitioning (at 312) the splats in each subset to two further divided subsets based on their proximity to one of the next pair of splats that are furthest from each other in each newly segmented subset. Nearest neighboring splats or splats that are positioned closest together are determined when only two splats remain in a newly segmented subset.

Process 300 includes associating (at 314) different pairs of splats that are nearest neighbors or that are positioned closest together as adjacent leaf nodes of the tree-based representations. Moreover, the pair of splats that are nearest neighbors may be associated with leaf nodes that are linked to the same parent node, and the leaf nodes may also be arranged according to the proximity of the associated splats. In other words, the leaf nodes that are connected to the same parent node are nearest neighbors and neighboring leaf nodes that are connected to different parent nodes are the next nearest neighbors.

Process 300 includes generating (at 316) Gaussian splats for each parent node based on the Gaussian splats that are associated with the children nodes of that parent node. For instance, a parent node may be directly connected to first and second leaf nodes that are associated with first and second Gaussian splats, and generating (at 316) the Gaussian splats for the parent node may include defining a splat primitive that spans the space or region of the 3D model covered or represented by the first and second Gaussian splats and that has color values and other visual characteristics derived from the color values and other visual characteristics of the first and second splats.

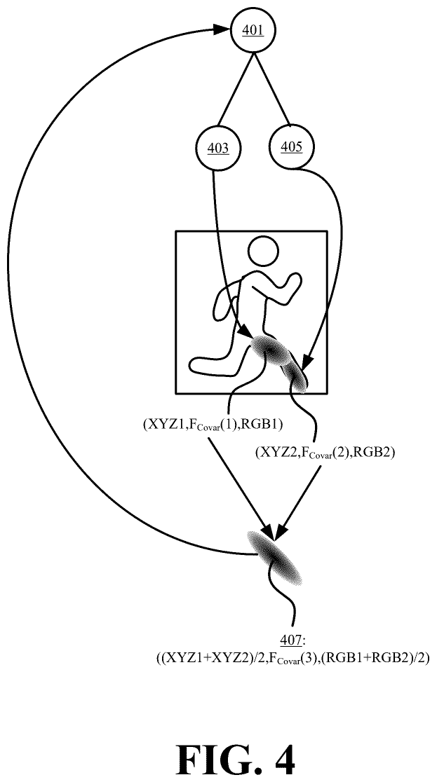

FIG. 4 illustrates an example of generating a Gaussian splat for a parent node in the tree-based representation based on the Gaussian splats that are associated with children nodes of the parent node in accordance with some embodiments presented herein. Parent node 401 is linked to first child node 403 and second child node 405.

First child node 403 is associated with a first Gaussian splat and second child node 405 is associated with a second Gaussian splat. The first Gaussian splat corresponds to a first splat primitive (e.g., a 3D oval) that is defined over a first region of 3D space to represent a first part of the 3D model. The first Gaussian splat is defined with a first set of visual characteristics that include a first set of color values. The second Gaussian splat corresponds to a second splat primitive that is defined over a second region of 3D space to represent a neighboring second part of the 3D model. The second Gaussian splat is defined with a second set of visual characteristics that include a different second set of color values.

Adaptive streaming system 100 defines summarized Gaussian splat 407 for parent node 401 to span the regions of space of the first and second Gaussian splats and closely match the combined shape of first and second Gaussian splats. In other words, summarized Gaussian splat 407 is defined to represent the first part of the 3D model that is represented in more detail or more accurately by the first Gaussian splat and the second part of the 3D model that is represented in more detail or more accurately by the second Gaussian splat. The splat primitive associated with summarized Gaussian splat 407 is therefore larger in size and spans a larger region of the 3D model than the splat primitives associated with either the first Gaussian splat or the second Gaussian splat, and is intended to replace the first and second Gaussian splats when data reduction is needed for the first and second parts of the 3D model. The positional coordinates for summarized Gaussian splat 407 may be at the center of the positional coordinates for the first Gaussian splat and the second Gaussian splat or otherwise derived from the positional coordinates of the first Gaussian splat and the second Gaussian splat.

Adaptive streaming system 100 defines the visual characteristics of summarized Gaussian splat 407 based on the first set of visual characteristics of the first Gaussian splat and the second set of visual characteristics of the second Gaussian splat. In some embodiments, adaptive streaming system 100 defines the visual characteristics of summarized Gaussian splat 407 by averaging the first set of visual characteristics and the second set of visual characteristics. In some other embodiments, adaptive streaming system 100 takes the weighted average of the first set of visual characteristics and the second set of visual characteristics in order to define the visual characteristics of summarized Gaussian splat 407. The weighted average may be biased based on the size of the first Gaussian splat (e.g., size of the first region of space represented by the first Gaussian splat) relative to the size of the second Gaussian (e.g., size of the second region of space represented by the second Gaussian splat). Adaptive streaming system 100 may recursively move up from the leaf nodes to the root node of the tree-based representation and define summarized Gaussian splats for the nodes at each level removed from the leaf node layer similar to the definition of parent node 401 in FIG. 4.

The tree-based representation that is generated as a result of executing process 300 includes Gaussian splats at different levels of detail and/or resolution that are hierarchically organized and arranged about the tree according to the region of the 3D model that is represented by each Gaussian splat. The Gaussian splats associated with nodes at higher levels of the tree (e.g., closer to the root node than the leaf nodes) represent larger parts of the 3D model and therefore less detail for those larger parts than the Gaussian splats associated with nodes at lower levels of the tree (e.g., closer to the leaf nodes than the root node) that represent smaller parts of the 3D model and therefore greater detail for those smaller parts. As such, the 3D model or any particular view of the 3D model may be generated with a non-uniform resolution at different parts based on different traversals down the tree-based representation and the selection and usage of Gaussian splats at the different levels of the tree-based representation that represent those different parts.

Adaptive streaming system 100 may optimize the tree-based representation generation to improve the visual quality associated with the Gaussian splats at the higher levels of the tree. For instance, rather than define the tree as a binary search tree in which every parent node has two children nodes, adaptive streaming system 100 may modify the tree structure to link parent and children nodes based on commonality in the associated Gaussian splats of the children nodes. The modified tree structure improves the visual quality of the higher level parent nodes by preventing the definition of summarized Gaussian splat from two unrelated and entirely different Gaussian splats of children nodes. For instance, neighboring children nodes may represent different sides about an edge of the 3D model that have completely different coloring. Rather than link these children nodes to the same parent node, adaptive streaming system may analyze the visual characteristics associated with each of the child nodes to determine that the visual characteristics differ by more than a threshold amount, and may link the children nodes to different parent nodes to preserve the visual detail and/or quality about the edge of the 3D model.

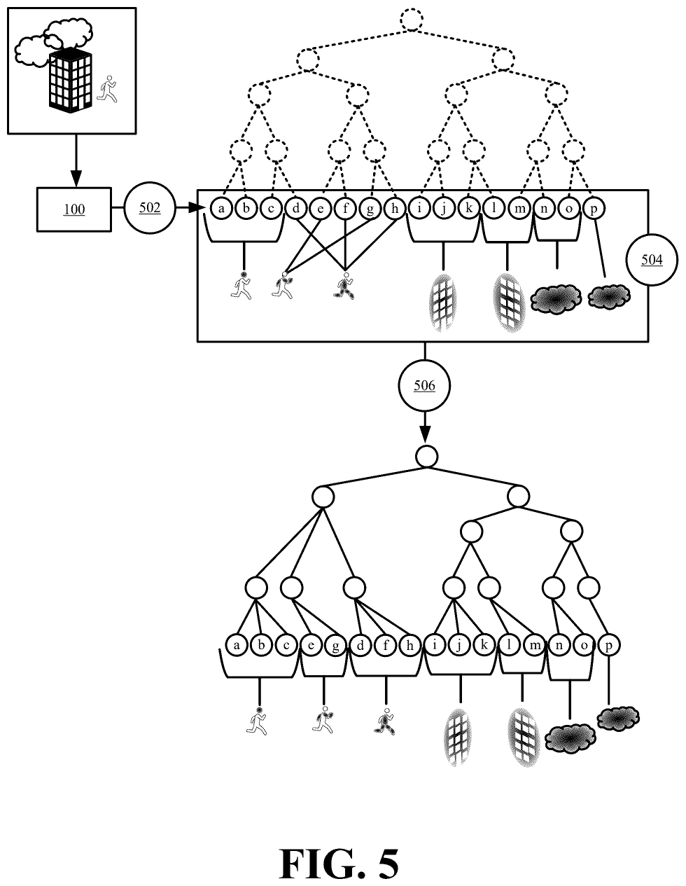

FIG. 5 illustrates an example of optimizing the tree-based representation in accordance with some embodiments presented herein. Adaptive streaming system 100 arranges (at 502) the leaf nodes and the associated Gaussian splats based on distance and/or the positioning of the represented regions of the 3D model.

Adaptive streaming system 100 compares (at 504) the visual characteristics of the Gaussian splats associated with neighboring nodes to detect nodes or the associated Gaussian splats that represent similar parts or elements of the 3D model and/or the associated Gaussian splats with commonality in their visual characteristics. For instance, adaptive streaming system 100 determines that neighboring leaf nodes associated with Gaussian splats that have less than a 10% difference in their color values represent the same or similar parts of the 3D model, whereas neighboring leaf nodes associated with Gaussian splats that have more than the 10% difference in their color values represent distinct parts of the 3D model such as edges, different materials, different surfaces, different visual elements, etc.

Adaptive streaming system 100 dynamically links (at 506) parent nodes to neighboring children nodes that are associated with Gaussian splats with a detected commonality. In some embodiments, adaptive streaming system 100 limits the number of children nodes that are linked to the same parent node in order to control or minimize the data reduction and/or quality loss between different levels of the tree-based representation. In some embodiments, dynamically linking (at 506) the parent nodes to the neighboring children nodes includes repositioning or rearranging non-neighboring children nodes that represent the same part of the 3D model or that share a visual characteristic commonality so that they are adjacent to one another in the leaf node layer of the tree-based representation.

The optimized tree-based representation may have an unbalanced structure with parent nodes being linked to different numbers of children nodes and some levels of the tree having no parent nodes for some of the leaf nodes. However, the unbalanced tree structure better organizes the nodes and associated Gaussian splats based on commonality so that there is less detail or quality lost in the summarized Gaussian splats that are generated from the children nodes.

Adaptive streaming system 100 stores the generated tree-based representations for different 3D models, and streams a requested view of a particular 3D model at different resolutions based on different traversals down different branches of the tree-based representation generated for the particular 3D model. The different traversals select Gaussian splats associated with nodes at the different levels of the tree-based representation with the selected Gaussian splats associated with the nodes at the different levels representing or encoding different parts for the requested view of the particular 3D model at different resolution, levels of detail, and/or with different sized splat primitives.

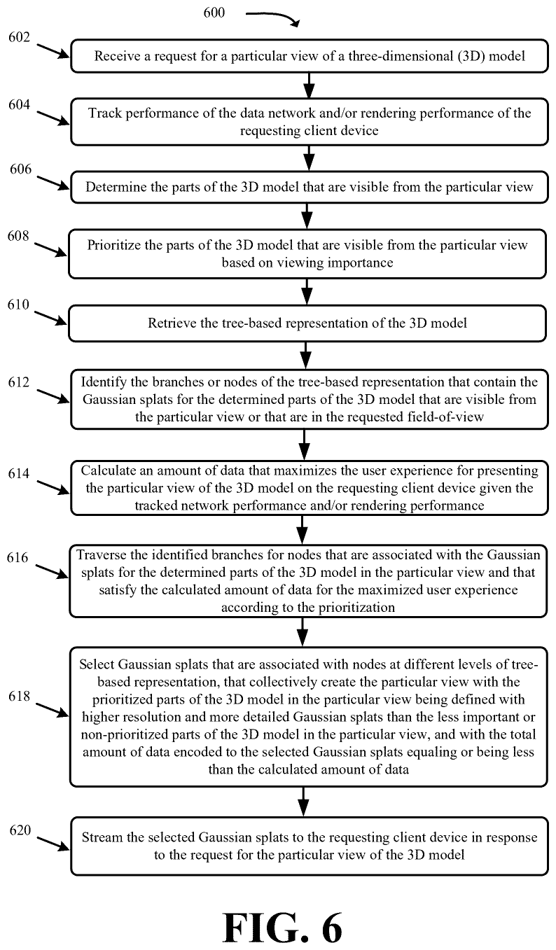

FIG. 6 presents a process 600 for presenting a requested view of a 3D model with differing resolutions across the requested view in accordance with some embodiments presented herein. Process 600 is implemented by adaptive streaming system 100.

Process 600 includes receiving (at 602) a request for a particular view of a 3D model. For instance, the requesting client device may issue a request to view the 3D model from a specific angle, perspective, distance, orientation, rotation, and/or side. In some embodiments, the request may specify a field-of-view or render position for a 3D environment or 3D space with the 3D model. For instance, the 3D model may be a visual element placed in a 3D world of a video game or spatial computing experience. The render position or the position of a virtual camera that establishes the user field-of-view in the 3D world may be at an angle or distance from the 3D model such that the entirety of the 3D model is not visible and the particular view of the 3D model falls within the user field-of-view or render position.

Process 600 includes tracking (at 604) performance of the network connecting adaptive streaming system 100 to the requesting client device and/or rendering performance of the requesting client device. Adaptive streaming system 100 may track the network performance based on the latency associated with the transmission of the request, time to establish a network connection or session between adaptive streaming system 100 and the requesting client device, and/or test packets exchanged between adaptive streaming system 100 and the requesting client device. Adaptive streaming system 100 may also track the network performance based on previous exchanges with the requesting client device or other client devices that are geographically proximate to the requesting client device. The previous exchanges may be used to develop a baseline measure of the network performance to requesting client device. Adaptive streaming system 100 may track the rendering performance from an identification or classification of the requesting client device. For instance, adaptive streaming system 100 may determine the device type from header parameters of the received (at 602) request, and each device type (e.g., mobile, headset, desktop, etc.) may be associated with different rendering performance. In some embodiments, the requesting client device may first login to a user account that stores information about the rendering performance of the requesting client device. In some embodiments, adaptive streaming system 100 may exchange one or more packets to query and/or determine rendering resources of the requesting client device (e.g., make and model of the processor, Graphics Processing Unit, memory, etc.).

Process 600 includes determining (at 606) the parts of the 3D model that are visible from the particular view. Adaptive streaming system 100 may perform various computations to determine the field-of-view that is associated with the requested particular view of the 3D model and the parts of the 3D model that fall within the field-of-view. In some embodiments, determining (at 606) the parts of the 3D model that are visible includes positioning a virtual camera in a 3D space with the 3D model based on the requested particular view and identifying the regions of the 3D space and/or 3D model that are within the field-of-view.

Process 600 includes prioritizing (at 608) the parts of the 3D model that are visible from the particular view based on viewing importance. In some embodiments, the prioritization (at 608) is performed without referencing the data or content associated with the visible parts of the 3D model. For instance, the parts of the 3D model that fall within the center of the field-of-view or in the foreground may be prioritized (at 608) over the parts of the 3D model that fall about the periphery or are in the background. In some embodiments, the prioritization (at 608) is based on the data or content associated with the visible parts of the 3D models. In some such embodiments, adaptive streaming system 100 may perform an image analysis to classify what each of the visible parts of the 3D model represents, and prioritize (at 608) the parts based on the classification. For instance, parts representing faces may be prioritized (at 608) over parts representing the neck, shoulders, and other body parts. Similarly, bodily parts may be prioritized (at 608) over parts of objects (e.g., accessories held in a character's hands). Parts with high variance (e.g., regions of the 3D model with many different colors, textures, positional variation, etc.) may be prioritized (at 608) over parts with low variance. In some embodiments, the prioritization (at 608) is based on previous tagging or ranking of the different parts of the 3D model. For instance, the Gaussian splats associated with the leaf nodes may be provided a priority when they are generated to indicate their importance in a rendered scene. In some such embodiments, a user may load the original 3D model, select different parts of the 3D models, and manually define a priority or importance for each selected part. When adaptive streaming system 100 generates the Gaussian splats for the 3D model, adaptive streaming system 100 may associate the priorities or importance for each selected part to the Gaussian splats that are generated to represent that part.

Process 600 includes retrieving (at 610) the tree-based representation of the 3D model. For instance, the request may specify the name of the 3D model, a path, or Uniform Resource Locator (URL) for accessing the 3D model from adaptive streaming system 100. Adaptive streaming system 100 may map the name, path, or URL to the tree-based representation that was generated for the 3D model.

Process 600 includes identifying (at 612) the branches or nodes of the tree-based representation that contain the Gaussian splats for the determined (at 606) parts of the 3D model that are visible from the particular view or that are in the requested field-of-view. Specifically, each node of the tree-based representation is associated with a Gaussian splat and each Gaussian splat represents a different region of the 3D model such that the identification (at 610) operation includes identifying the Gaussian splat represented regions that are within the requested particular view. In some embodiments, the identification (at 612) includes determining the coordinates for the requested particular view and identifying the nodes of the tree-based representation that contain Gaussian splats having positions within the coordinates.

Process 600 includes calculating (at 614) an amount of data that maximizes the user experience for presenting the particular view of the 3D model on the requesting client device given the tracked (at 604) network performance and/or rendering performance. In some embodiments, maximizing the user experience includes determining the maximum amount of data that may be streamed and/or rendered by the requesting client device in order to achieve a desired frame rate, lag-free accessibility and/or interactivity, no buffering or stuttering, real-time service, and/or other desired quality-of-service given the network performance and/or rendering performance. In some embodiments, maximizing the user experience includes providing the particular view of the 3D model with the least amount of loss in an acceptable amount of time.

Process 600 includes traversing (at 616) the identified (at 612) branches of the tree-based representation for nodes that are associated with the Gaussian splats for the determined (at 606) parts of the 3D model in the particular view and that satisfy the calculated (at 614) amount of data for the maximized user experience according to the prioritization (at 608). The traversal (at 616) includes moving further down the branches to nodes that are associated with Gaussian splats containing more detailed representations for the prioritized (at 608) parts of the particular view and staying at a higher level of the tree structure for nodes that are associated with Gaussian splats containing less detailed representations for the less important or non-prioritized (at 608) parts of the particular view, and identifying a combination of Gaussian splats that total the calculated (at 614) amount of data, that maximize quality of the important parts in the particular view, and that minimize total quality loss across the particular view.

Process 600 includes selecting (at 618) Gaussian splats that are associated with nodes at different levels of tree-based representation, that collectively create the particular view with the prioritized (at 608) parts of the 3D model in the particular view being defined with higher resolution and more detailed Gaussian splats than the less important or non-prioritized (at 608) parts of the 3D model in the particular view, and with the total amount of data encoded to the selected (at 618) Gaussian splats equaling or being less than the calculated (at 614) amount of data that maximizes the user experience. In particular, adaptive streaming system 100 selects (at 616) more Gaussian splats that encode the visual characteristics for smaller sized regions of the 3D model to represent the prioritized (at 608) parts of the 3D model in the particular view and selects (at 618) fewer Gaussian splats that encode the visual characteristics for larger sized regions of the 3D model to represent the less important or non-prioritized (at 608) parts of the 3D model in the particular view.

Process 600 includes streaming (at 620) the selected (at 618) Gaussian splats to the requesting client device in response to the request for the particular view of the 3D model. The selected (at 618) Gaussian splats may be transmitted in any order as each Gaussian splat contains the visual data for a different sized and/or positioned splat primitive that forms a different part of the 3D model. For instance, adaptive streaming system 100 may stream ten Gaussian splats for a first part of the particular view that spans a particular sized region and may stream two Gaussian splats for a second of the particular view that spans the same particular sized region at a different position about the 3D model. The ten Gaussian splats for the first part of the particular view include smaller sized splat primitives that can be used to recreate the first part with greater visual accuracy than the two Gaussian splats for the second part of the particular view. The two Gaussian splats can represent two variations about the second part of the particular view whereas the ten Gaussian splats can represent ten variations about the first part of the particular view. In this example, the first part of the particular view may have five times the resolution as the second part of the particular view.

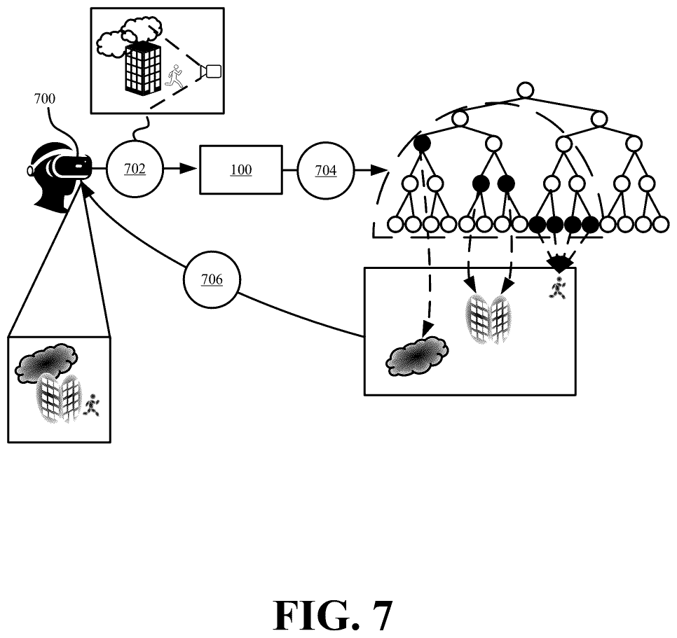

FIG. 7 illustrates an example of generating different parts of a requested field-of-view at different resolutions using dynamically selected and streamed Gaussian splats in accordance with some embodiments presented herein. Client device 700 issues (at 702) a request to view a 3D model from the requested field-of-view. The request is routed or forwarded to adaptive streaming system 100 across a data network.

Adaptive streaming system 100 selects (at 704) a set of Gaussian splats from a tree-based representation of the 3D model that collectively present the requested field-of-view with different levels of detail at different parts of the requested field-of-view so that the total amount of data contained in the set of Gaussian splats may be streamed and rendered on client device 700 in a threshold amount of time that eliminates buffering, lag, or long waits that degrade the user experience without excessively or uniformly lowering the detail and/or visual quality of the requested field-of-view. In other words, adaptive streaming system 100 selects (at 704) the set of Gaussian splats to ensure a consistent user experience and to maximize the detail and/or visual quality of the requested field-of-view based on the tracked network performance and/or rendering performance of the requesting device.

Adaptive streaming system 100 streams (at 706) the selected set of Gaussian splats to client device 700. Client device 700 receives (at 706) the selected set of Gaussian splats and renders (at 708) the requested field-of-view with a varying resolution based on the data contained in each of the received Gaussian splats. Each Gaussian splat provides visual data for a different region of the requested field-of-view. In particular, each Gaussian splat may be encoded with the same amount of data and may include the definition for a single splat primitive. For instance, the single splat primitive may be defined with a 3D position, orientation, 3D scaling factor, and visual characteristics. However, higher resolution Gaussian splats selected from lower levels of the tree-based representation (e.g., leaf nodes or nodes closer to the leaf nodes than the root node) define splat primitives and visual characteristics for a smaller region of the requested field-of-view than lower resolution Gaussian splats selected from higher levels of the tree-based representation (e.g., nodes closer to the root node than the leaf nodes). In other words, more unique detail, structural or positional variance, and color variance may be presented in the regions of the requested field-of-view generated from rendering (at 708) the higher resolution Gaussian splats and less detail, structural or positional variance, and color variance may be presented in the regions of the requested field-of-view generated from rendering (at 708) the lower resolution Gaussian splats. As shown in FIG. 7, a first number of small Gaussian splats are used to render the 3D character in the foreground with high detail due the 3D character being assigned the highest priority for all visual elements in the 3D model, a second number of larger Gaussian splats are used to render the building at the center of the field-of-view but behind the 3D character, and a third number of largest Gaussian splats are used to render the clouds in the background and in the periphery. The second number of Gaussian splats used to render the building is less than the first number of Gaussian splats used to render the smaller 3D character so that the 3D character can be presented with greater detail and at higher resolution than the building that is of less importance in the field-of-view. Moreover, the greatest data reduction is achieved by rendering the clouds with the fewest Gaussian splats and additional data reduction is achieved by rendering the building with fewer Gaussian splats than the 3D character. Accordingly, more data may be allocated to the rendering of the 3D character at a higher resolution or level-of-detail.

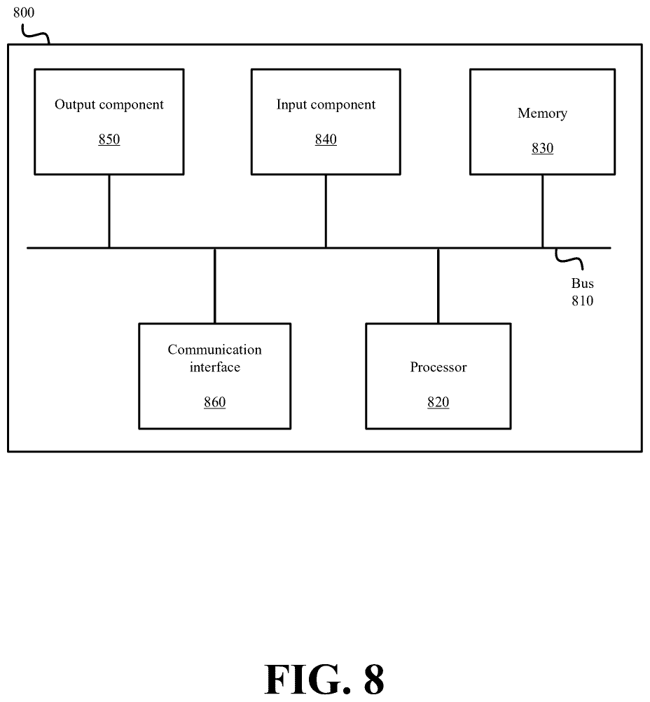

FIG. 8 is a diagram of example components of device 800. Device 800 may be used to implement one or more of the tools, devices, or systems described above (e.g., adaptive streaming system 100, client devices 101 and 700, etc.). Device 800 may include bus 810, processor 820, memory 830, input component 840, output component 850, and communication interface 860. In another implementation, device 800 may include additional, fewer, different, or differently arranged components.

Bus 810 may include one or more communication paths that permit communication among the components of device 800. Processor 820 may include a processor, microprocessor, or processing logic that may interpret and execute instructions. Memory 830 may include any type of dynamic storage device that may store information and instructions for execution by processor 820, and/or any type of non-volatile storage device that may store information for use by processor 820.

Input component 840 may include a mechanism that permits an operator to input information to device 800, such as a keyboard, a keypad, a button, a switch, etc. Output component 850 may include a mechanism that outputs information to the operator, such as a display, a speaker, one or more LEDs, etc.

Communication interface 860 may include any transceiver-like mechanism that enables device 800 to communicate with other devices and/or systems. For example, communication interface 860 may include an Ethernet interface, an optical interface, a coaxial interface, or the like. Communication interface 860 may include a wireless communication device, such as an infrared (IR) receiver, a Bluetooth® radio, or the like. The wireless communication device may be coupled to an external device, such as a remote control, a wireless keyboard, a mobile telephone, etc. In some embodiments, device 800 may include more than one communication interface 860. For instance, device 800 may include an optical interface and an Ethernet interface.

Device 800 may perform certain operations relating to one or more processes described above. Device 800 may perform these operations in response to processor 820 executing software instructions stored in a computer-readable medium, such as memory 830. A computer-readable medium may be defined as a non-transitory memory device. A memory device may include space within a single physical memory device or spread across multiple physical memory devices. The software instructions may be read into memory 830 from another computer-readable medium or from another device. The software instructions stored in memory 830 may cause processor 820 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more. ” Where only one item is intended, the terms “one,” “single,” “only,” or similar language is used. Further, the phrase “based on” is intended to mean “based, at least in part, on” unless explicitly stated otherwise.

1. A method comprising:
receiving a request to view a three-dimensional (3D) model from a particular field-of-view;
associating different priorities to different parts of the 3D model in the particular field-of-view;
selecting a first set of Gaussian splats associated with nodes at a first level in a tree structure based on the first set of Gaussian splats representing the different parts of the 3D model in the particular field-of-view with a first priority;
selecting a second set of Gaussian splats associated with nodes at a second level in the tree structure based on the second set of Gaussian splats representing the different parts of the 3D model in the particular field-of-view with a second priority that is different than the first priority; and
streaming the first set of Gaussian splats and the second set of Gaussian splats in response to the request.

2. The method of claim 1 further comprising:
generating the first set of Gaussian splats at a first resolution; and
generating the second set of Gaussian splats at a second resolution that is different than the first resolution.

3. The method of claim 1 further comprising:
generating each Gaussian splat of the first set of Gaussian splats to represent a region of the 3D model that is a first size; and
generating each Gaussian splat of the second set of Gaussian splats to represent a region of the 3D model that is a second size, wherein the second size is larger than the first size.

4. The method of claim 1 further comprising:
associating the first set of Gaussian splats to a plurality of leaf nodes of the tree structure; and
associating the second set of Gaussian splats to a plurality of parent nodes of the tree structure that are one or more levels above the plurality of leaf nodes based on each Gaussian splat from the second set of Gaussian splats representing parts of the 3D model that are represented by two or more Gaussian splats from the first set of Gaussian splats.

5. The method of claim 1 further comprising:
associating the first set of Gaussian splats to a plurality of leaf nodes of the tree structure based on the first set of Gaussian splats representing the different parts of the 3D model with the first priority at a first resolution or a first level-of-detail; and
associating the second set of Gaussian splats to a plurality of parent nodes of the tree structure that are one or more levels above the plurality of leaf nodes based on the second set of Gaussian splats representing the different parts of the 3D model with the second priority at a second resolution or a second level-of-detail that is different than the first resolution or the first level-of-detail.

6. The method of claim 1 further comprising:
associating the first set of Gaussian splats to a plurality of leaf nodes of the tree structure; and
generating each Gaussian splat of the second set of Gaussian splats to span a shape of two or more different Gaussian splats from the first set of Gaussian splats and to have visual characteristics that are derived from visual characteristics of the two or more different Gaussian splats.

7. The method of claim 1 further comprising:
generating the particular field-of-view with different resolutions based on the first set of Gaussian splats representing the different parts of the 3D model in the particular field-of-view with the first priority with a first amount of detail and the second set of Gaussian splats representing the different parts of the 3D model in the particular field-of-view with the second priority with a different second amount of detail.

8. The method of claim 1 further comprising:
determining a performance of a network used to exchange the request, the first set of Gaussian splats, and the second set of Gaussian splats; and
determining that Gaussian splats representing the different parts of the 3D model in the particular field-of-view at the first level of the tree structure do not provide a desired user experience based on the performance of the network.

9. The method of claim 8, wherein selecting the second set of Gaussian splats comprises:
determining that the first set of Gaussian splats and the second set of Gaussian splats collectively produce the particular field-of-view at different resolution with a total amount of data that provides the desired user experience based on the performance of the network.

10. The method of claim 1 further comprising:
retrieving the tree structure in response to receiving the request, wherein the tree structure comprises a plurality of nodes that are linked hierarchically with two or more children nodes to each parent node and with each node of the plurality of nodes at a different level of the tree structure being associated with a Gaussian splat for representing a part of the 3D model with a different resolution.

11. An adaptive streaming system comprising:
one or more hardware processors configured to:
receive a request to view a three-dimensional (3D) model from a particular field-of-view;
associate different priorities to different parts of the 3D model in the particular field-of-view;
select a first set of Gaussian splats associated with nodes at a first level in a tree structure based on the first set of Gaussian splats representing the different parts of the 3D model in the particular field-of-view with a first priority;
select a second set of Gaussian splats associated with nodes at a second level in the tree structure based on the second set of Gaussian splats representing the different parts of the 3D model in the particular field-of-view with a second priority that is different than the first priority; and
stream the first set of Gaussian splats and the second set of Gaussian splats in response to the request.

12. The adaptive streaming system of claim 11, wherein the one or more hardware processors are further configured to:
generate the first set of Gaussian splats at a first resolution; and
generate the second set of Gaussian splats at a second resolution that is different than the first resolution.

13. The adaptive streaming system of claim 11, wherein the one or more hardware processors are further configured to:
generate each Gaussian splat of the first set of Gaussian splats to represent a region of the 3D model that is a first size; and
generate each Gaussian splat of the second set of Gaussian splats to represent a region of the 3D model that is a second size, wherein the second size is larger than the first size.

14. The adaptive streaming system of claim 11, wherein the one or more hardware processors are further configured to:
associate the first set of Gaussian splats to a plurality of leaf nodes of the tree structure; and
associate the second set of Gaussian splats to a plurality of parent nodes of the tree structure that are one or more levels above the plurality of leaf nodes based on each Gaussian splat from the second set of Gaussian splats representing parts of the 3D model that are represented by two or more Gaussian splats from the first set of Gaussian splats.

15. The adaptive streaming system of claim 11, wherein the one or more hardware processors are further configured to:
associate the first set of Gaussian splats to a plurality of leaf nodes of the tree structure based on the first set of Gaussian splats representing the different parts of the 3D model with the first priority at a first resolution or a first level-of-detail; and
associate the second set of Gaussian splats to a plurality of parent nodes of the tree structure that are one or more levels above the plurality of leaf nodes based on the second set of Gaussian splats representing the different parts of the 3D model with the second priority at a second resolution or a second level-of-detail that is different than the first resolution or the first level-of-detail.

16. The adaptive streaming system of claim 11, wherein the one or more hardware processors are further configured to:
associate the first set of Gaussian splats to a plurality of leaf nodes of the tree structure; and
generate each Gaussian splat of the second set of Gaussian splats to span a shape of two or more different Gaussian splats from the first set of Gaussian splats and to have visual characteristics that are derived from visual characteristics of the two or more different Gaussian splats.

17. The adaptive streaming system of claim 11, wherein the one or more hardware processors are further configured to:
generate the particular field-of-view with different resolutions based on the first set of Gaussian splats representing the different parts of the 3D model in the particular field-of-view with the first priority with a first amount of detail and the second set of Gaussian splats representing the different parts of the 3D model in the particular field-of-view with the second priority with a different second amount of detail.

18. The adaptive streaming system of claim 11, wherein the one or more hardware processors are further configured to:
determine a performance of a network used to exchange the request, the first set of Gaussian splats, and the second set of Gaussian splats; and
determine that Gaussian splats representing the different parts of the 3D model in the particular field-of-view at the first level of the tree structure do not provide a desired user experience based on the performance of the network.

19. The adaptive streaming system of claim 18, wherein selecting the second set of Gaussian splats comprises:
determining that the first set of Gaussian splats and the second set of Gaussian splats collectively produce the particular field-of-view at different resolution with a total amount of data that provides the desired user experience based on the performance of the network.

20. A non-transitory computer-readable medium storing instructions that, when executed by one or more processors of an adaptive streaming system, cause the adaptive streaming system to perform operations comprising:
receiving a request to view a three-dimensional (3D) model from a particular field-of-view;
associating different priorities to different parts of the 3D model in the particular field-of-view;
selecting a first set of Gaussian splats associated with nodes at a first level in a tree structure based on the first set of Gaussian splats representing the different parts of the 3D model in the particular field-of-view with a first priority;
selecting a second set of Gaussian splats associated with nodes at a second level in the tree structure based on the second set of Gaussian splats representing the different parts of the 3D model in the particular field-of-view with a second priority that is different than the first priority; and
streaming the first set of Gaussian splats and the second set of Gaussian splats in response to the request.
